(19) United States
(12) Patent Application Publication
(10) Pub. No.: US 2023/0124926 A1
(43) Pub. Date: Apr. 20, 2023

(54) APPARATUS FOR TREATING GASEOUS POLLUTANTS

(71) Applicant: ECOSYS PTE. LTD., Kallang (SG)

(72) Inventor: Chee Wei CHAN, Kallang (SG)

(21) Appl. No.: 18/085,288

(22) Filed: Dec. 20, 2022

Related U.S. Application Data
(63) Continuation of application No. PCT/SG2021/050330, filed on Jun. 8, 2021.
(60) Provisional application No. 63/043,375, filed on Jun. 24, 2020.

(51) Int. Cl. B01D 53/75; B01D 53/04; B01D 53/14; B01D 53/38

(52) U.S. Cl. CPC B01D 53/75; B01D 53/0446; B01D 53/1437; B01D 53/1493; B01D 53/38; B01D 2258/0216; B01D 2259/124; B01D 2259/128; B01D 2259/401; B01D 2252/103

(57) ABSTRACT

An apparatus for treating gaseous pollutants includes a gas inlet part, a first treatment unit, a second treatment unit and a non-mechanical flow-guiding device. The gas inlet part includes a gas inlet chamber and at least one guide pipe. The guide pipe communicates with the gas inlet chamber and guides an effluent stream from a semiconductor process to the gas inlet chamber. The first treatment unit is coupled to a bottom end of the gas inlet part and is configured to abate the effluent stream. The non-mechanical flow-guiding device is coupled to the first treatment unit. The flow-guiding device is configured to guide the effluent stream to move toward an opening. The second treatment unit is coupled to the flow-guiding device via the opening, receives the effluent stream from the first treatment unit and further abates the effluent stream.

### FIELD OF THE INVENTION

The present invention relates to an apparatus for treating gaseous pollutants, in particular to an apparatus for treating an effluent stream from a semiconductor process.

### BACKGROUND OF THE INVENTION

Waste gas in a semiconductor process contains a variety of chemical substances harmful to the human body or the environment. Common apparatuses for treating waste gas includes a combustion type apparatus, a plasma type apparatus, a water scrubbing type apparatus and a catalytic type apparatus.

For water-soluble harmful substances, the water scrubbing type (or referred to as wet type) apparatus for treating waste gas has the advantages of reasonable purchase cost and easy installation. In practical applications, it is often used with an epitaxial process or a semiconductor etching process. The water scrubbing type apparatus for treating waste gas in the prior art can be seen in US Patent Publication No. US20100119420, which discloses an abatement system with enhanced effluent scrubbing and moisture control, including a discharge guide tube, a plurality of packed beds, one or more spray heads and a dripper. The discharge guide tube is configured to enable an effluent stream to flow therethrough. The packed beds are disposed in the discharge guide tube to remove a non-drainable effluent from the effluent stream. The spray heads are configured to provide an effluent treatment agent between the adjacent packed beds. The effluent treatment agent is configured to remove the non-drainable effluent from the effluent stream. The dripper is disposed in the discharge guide tube, positioned above the uppermost packed bed and configured to provide the effluent treatment agent with large droplets, so as to substantially wet and rinse microparticles from an upper surface of the uppermost packed bed without the formation of fine droplets.

For pollutants such as silane, arsine, phosphine and the like produced by a chemical vapor deposition (CVD) process, the combustion type apparatus for treating waste gas is often used. Traditional commercial products include LARCH model machines from DAS or Spectra series machines from Edwards.

### BRIEF DESCRIPTION OF THE DRAWINGS

FIG. 1 is a schematic diagram according to some embodiments of the present invention.

FIG. 2A is a schematic diagram according to an aspect of an embodiment of FIG. 1.

FIG. 2B is a schematic diagram according to another aspect of an embodiment of FIG. 1.

FIG. 3A is a schematic three-dimensional diagram according to an embodiment of the present invention.

FIG. 3B is a schematic three-dimensional diagram taken from another viewing angle according to an embodiment of the present invention.

FIG. 4 is a top view according to an embodiment of the present invention.

FIG. 5 is a schematic cross-sectional top view taken along A-A of FIG. 1.

FIG. 6 is a schematic three-dimensional cross-sectional view taken along B-B of FIG. 4.

FIG. 7A to FIG. 7B are schematic cross-sectional views taken along B-B of FIG. 4.

FIG. 8 is a schematic three-dimensional cross-sectional view taken along C-C of FIG. 4.

FIG. 9 is a schematic cross-sectional view taken along C-C of FIG. 4.

FIG. 10 is a schematic diagram according to an embodiment of the present invention.

### SUMMARY OF THE INVENTION

One aspect of the present invention provides an apparatus for treating gaseous pollutants comprising a gas inlet part, a first scrubbing tower, a second scrubbing tower, a third scrubbing tower, and a circulating water tank. The gas inlet part comprises a gas inlet chamber and at least one guide pipe, the at least one guide pipe communicates with the gas inlet chamber and guiding an effluent stream from a semiconductor process to the gas inlet chamber. The first scrubbing tower is coupled to a bottom end of the gas inlet part, extends vertically, and comprises a first top opening communicating with the gas inlet chamber, a first chamber communicates with the first top opening, an inner wall is positioned in the first chamber, a liquid inlet laterally communicates with the first chamber, and a first bottom opening communicates with the first chamber, the liquid inlet is configured to allow a water flow entering the first chamber so as to form a water curtain on the inner wall. The second scrubbing tower is disposed adjacent to the first scrubbing tower, extends vertically, and comprises a second bottom opening communicating with the first chamber, a second chamber communicates with the second bottom opening, a second top opening communicates with the second chamber, and a plurality of eductors are disposed in the second chamber. The third scrubbing tower is disposed adjacent to the second scrubbing tower, extends vertically, and comprises a third top opening communicating with the second chamber, a third chamber communicates with the third top opening, a third bottom opening communicates with the third chamber, a flow-guiding device is disposed adjacent to the third top opening, and at least one packed bed is positioned below the flow-guiding device to receive a gas flow from the flow-guiding device. The circulating water tank, is coupled to bottom ends of the first scrubbing tower, the second scrubbing tower and the third scrubbing tower, and comprises a water collection space for storing a liquid, a first upper opening, a second upper opening and a third upper opening, the first upper opening, the second upper opening and the third upper opening respectively communicate with the first chamber, the second chamber and the third chamber, and the water collection space comprises a first region, a second region and a barrier disposed between the first region and the second region. The first region forms, between the first bottom opening of the first scrubbing tower and the second bottom opening of the second scrubbing tower, a first flow channel exposed to the liquid and configured to allow the effluent stream flowing from the first scrubbing tower to the third scrubbing tower through the second scrubbing tower, and the second region receives the effluent stream driven by the flow-guiding device of the third scrubbing tower.

Another aspect of the present invention provides an apparatus for treating gaseous pollutants comprising a first space, a second space, and a flow-guiding device. The first space is coupled to a gas source and receives a gaseous pollutant from the gas source, and the first space defines an inflow region. The second space is fluidly connected to the first space, and the second space defines an outflow region. The flow-guiding device is installed in a first channel between the outflow region and the inflow region, the first channel extends in a direction, the flow-guiding device comprises a fluid supply tube and a flow-guiding tube, the fluid supply tube and the flow-guiding tube are spaced apart from each other along the direction, and a second channel is positioned in the first channel and formed between the fluid supply tube and the flow-guiding tube, wherein the fluid supply tube supplies an injection fluid to the flow-guiding tube, whereby a pressure difference is generated between the first channel and the second channel, and the pressure difference drives the gaseous pollutant to enter the outflow region from the inflow region.

A further aspect of the present invention provides an apparatus for treating gaseous pollutants comprises a gas inlet part, a first treatment unit, a non-mechanical flow-guiding device, and a second treatment unit. The gas inlet part comprises a gas inlet chamber and at least one guide pipe, and the at least one guide pipe communicates with the gas inlet chamber and guides an effluent stream from a semiconductor process to the gas inlet chamber. The first treatment unit is coupled to a bottom end of the gas inlet part and is configured to abate the effluent stream. The non-mechanical flow-guiding device is coupled to the first treatment unit and is configured to guide the effluent stream to move toward an opening. The second treatment unit is coupled to the flow-guiding device via the opening, and the second treatment unit receives the effluent stream from the first treatment unit and further abating the effluent stream.

### DETAILED DESCRIPTION OF THE PREFERRED EMBODIMENTS

One aspect of the present invention discloses an apparatus for treating gaseous pollutants, which is applied to a treatment of an effluent stream from a semiconductor process, such as waste gas. Hereinafter, although the word “water” is used in various places, it is only for the convenience of description. The present invention is not limited to water, and all other liquids capable of cleaning or capturing particulate matter (PM) can be used.

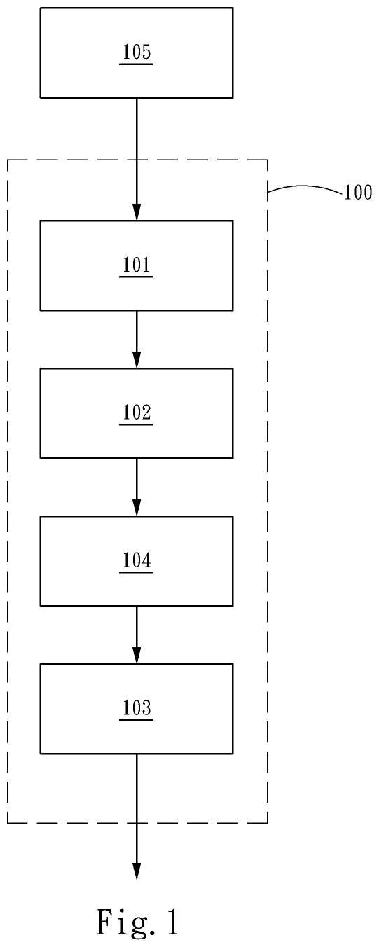

Referring to FIG. 1, an embodiment of the present invention discloses an apparatus 100 for treating gaseous pollutants, including a gas inlet part 101, a first treatment unit 102, a second treatment unit 103 and a non-mechanical flow-guiding device 104. The gas inlet part 101 guides an effluent stream 105 from a semiconductor process to the first treatment unit 102. The first treatment unit 102 is configured to abate the effluent stream. The non-mechanical flow-guiding device 104 is coupled between the first treatment unit 102 and the second treatment unit 103, and is configured to guide the effluent stream 105 to move toward the second treatment unit 103. The second treatment unit 103 receives the effluent stream 105 from the first treatment unit 102 and further abates the effluent stream 105.

In an embodiment, the first treatment unit 102 and the second treatment unit 103 may be same or different waste gas treatment units, for example, both the first treatment unit 102 and the second treatment unit 103 are water scrubbing type treatment units. Taking an example, the first treatment unit 102 may be a spray scrubber, and the second treatment unit 103 may be a packed bed scrubber. In some embodiments, a front end of the first treatment unit 102 may be further coupled to other forms of scrubbers or waste gas treatment units, and a rear end of the second treatment unit 103 may also be further coupled to other forms of scrubbers or waste gas treatment units. According to other embodiments of the present invention, the first treatment unit 102 and/or the second treatment unit may also be, for example, a combustion type, heating type or plasma type waste gas treatment unit.

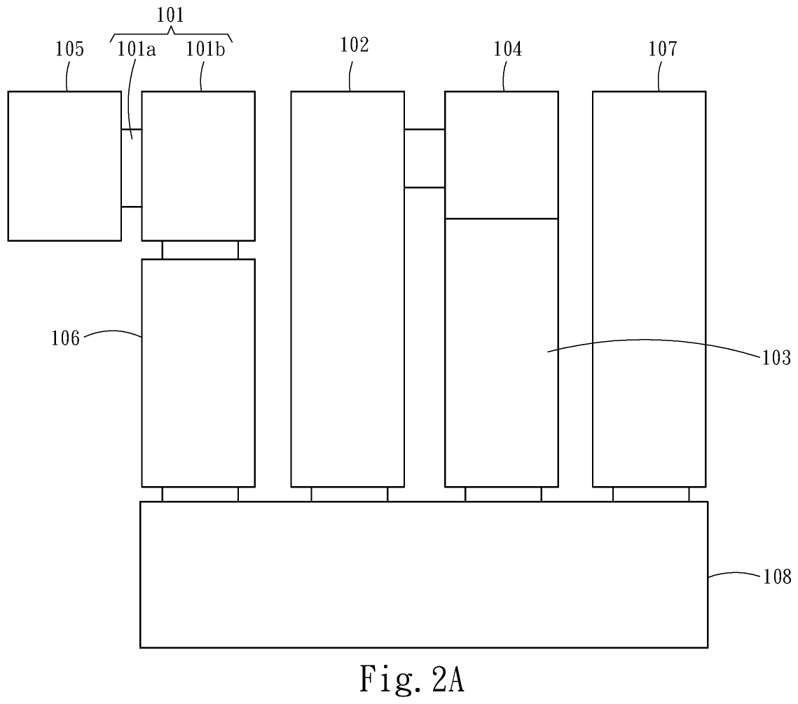

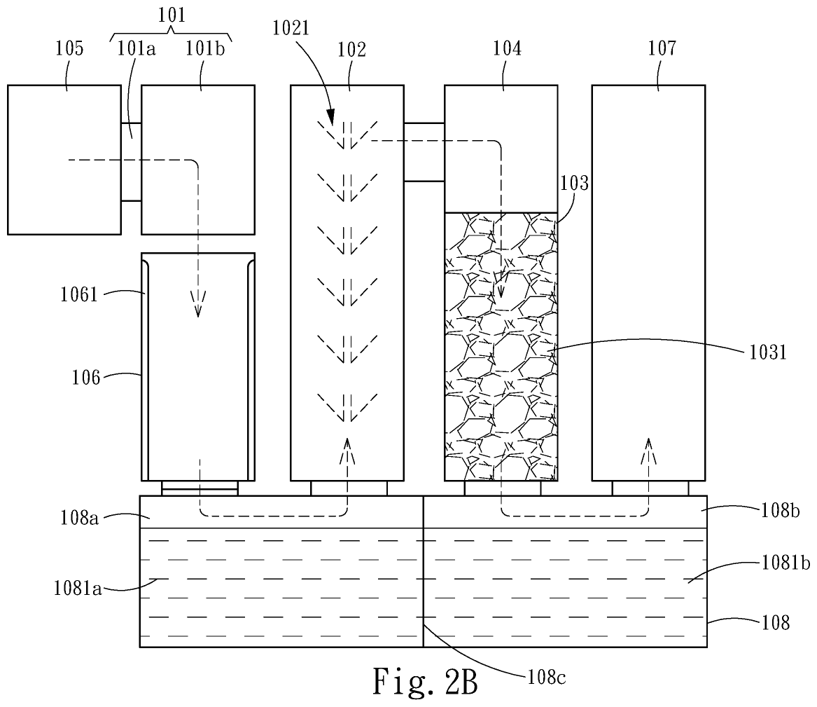

Further referring to FIG. 2A, a schematic diagram according to an aspect of an embodiment of FIG. 1. In an embodiment of the present invention, the gas inlet part 101 includes at least one guide pipe 101a and a gas inlet chamber 101b. The at least one guide pipe 101a communicates with the gas inlet chamber 101b and guides the effluent stream 105 to the gas inlet chamber 101b. The first treatment unit 102 is coupled to a rear end of the gas inlet part 101. The non-mechanical flow-guiding device 104 is coupled between the first treatment unit 102 and the second treatment unit 103, and is configured to guide the effluent stream 105 to move toward the second treatment unit 103. In this embodiment, the front end of the first treatment unit 102 is further coupled to a third treatment unit 106, the rear end of the second treatment unit 103 is further coupled to a fourth treatment unit 107, and the third treatment unit 106 is disposed below the gas inlet part 101. Bottom ends of the first treatment unit 102, the second treatment unit 103, the third treatment unit 106 and the fourth treatment unit 107 are coupled to a water tank unit 108. Operationally, the effluent stream 105 enters the third treatment unit 106 from the gas inlet chamber 101b, and enters the first treatment unit 102 through the water tank unit 108; and the effluent stream 105 is further guided to the second treatment unit 103 by using the non-mechanical flow-guiding device 104, and then enters the fourth treatment unit 107 through the water tank unit 108.

Referring to FIG. 2B, a schematic diagram according to another aspect of an embodiment of FIG. 1. In this example, the third treatment unit 106 is a water curtain scrubber, which provides a water curtain 1061 to flush the effluent stream 105, so as to prevent dust or particles of the effluent stream 105 from adhering to a wall surface; the first treatment unit 102 is a spray scrubber, which provides a plurality of sprays 1021 to capture the particles larger 5 μm in the effluent stream 105; and the second treatment unit 103 is a packed bed scrubber, which is stacked with a plurality of packings 1031 and configured to separate remaining particles in the effluent stream 105. In this example, the water tank unit 108 includes a first part 108a, a second part 108b and a partition 108c in which at least partially separating the first part 108a from the second part 108b, and the first part 108a and the second part 108b store water 1081a, 1081b respectively. The effluent stream 105 flows between the third treatment unit 106 and the first treatment unit 102 via an upper part (above the water 1081a) of the first part 108a; and the effluent stream 105 flows between the second treatment unit 103 and the fourth treatment unit 107 via an upper part (above the water 1081b) of the second part 108b.

In the present invention, the non-mechanical flow-guiding device 104 is a non-mechanical fluid conveying apparatus, that is, not a mechanical fluid conveying apparatus in forms of a pump, a blower or a compressor. The non-mechanical flow-guiding device 104 is driven by a fluid and generates a suction force by which the effluent stream 105 is driven to flow in the apparatus for treating gaseous pollutants. The prior art adopts the mechanical fluid conveying apparatus (such as pump) as a flow-guiding device for an effluent stream. The effluent stream in the semiconductor process usually contains a large amount of highly flammable and/or explosive gases (such as H₂, CH₄), and a high risk of severe explosion or combustion for gases due to friction with a mechanical structure or oil in the flow-guiding device. Since a mechanism for converting mechanical energy into pressure energy is not required in the non-mechanical flow-guiding device 104 in the present invention, the aforementioned risk may be reduced, the safety of a manufacturing process and operation is greatly improved, and more energy is saved.

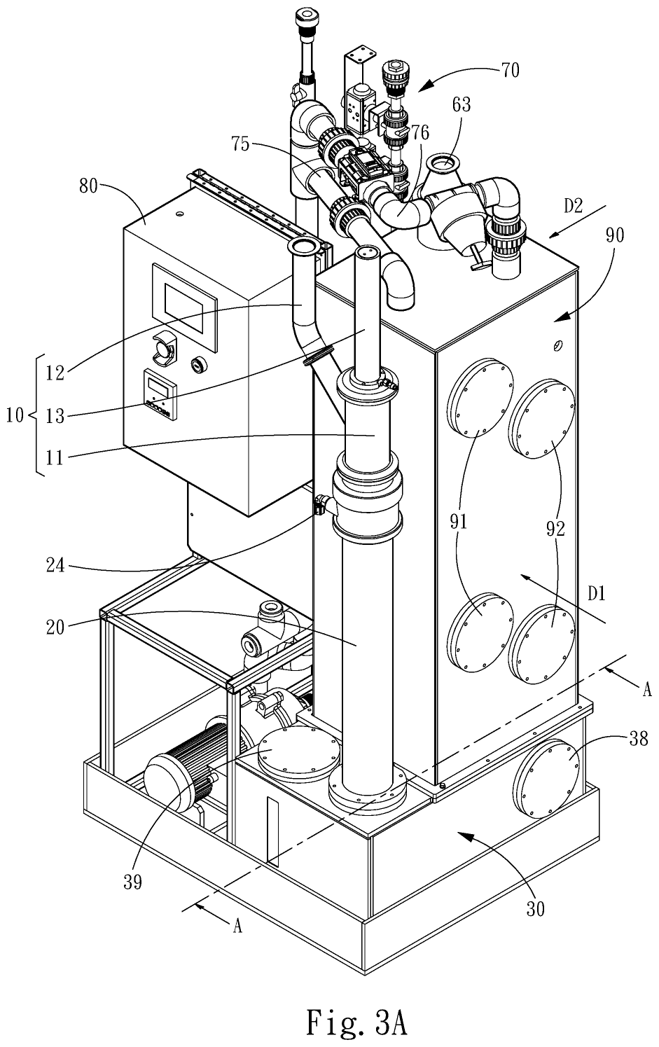

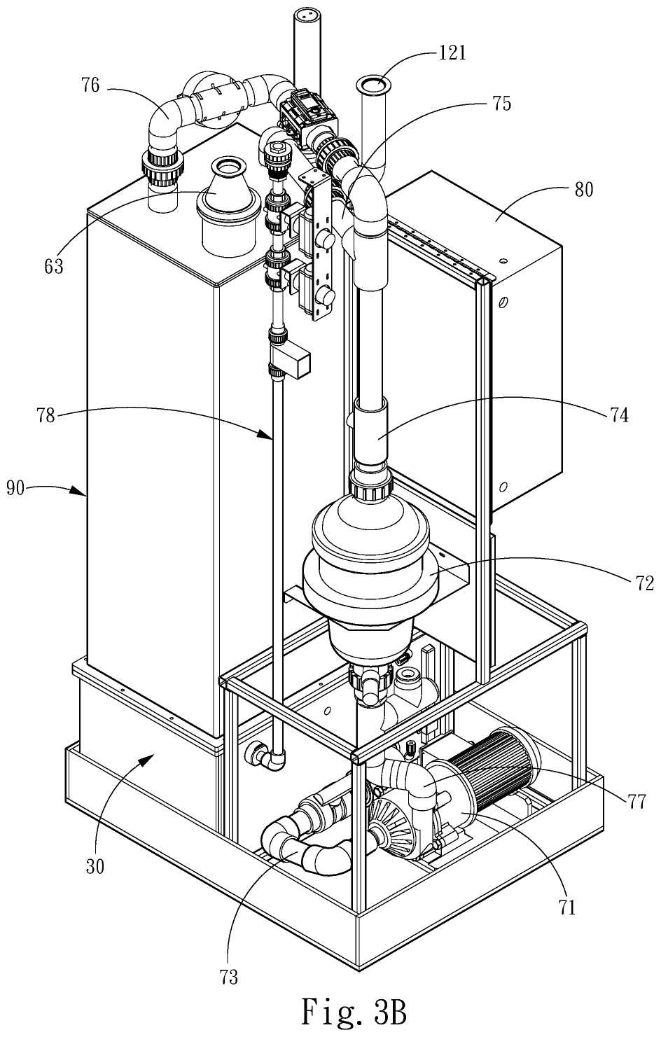

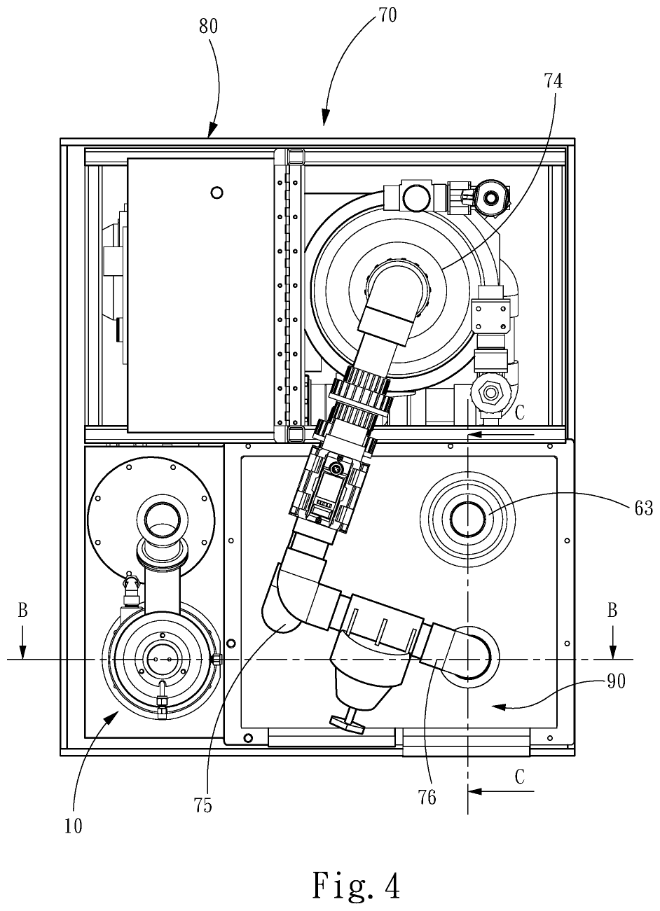

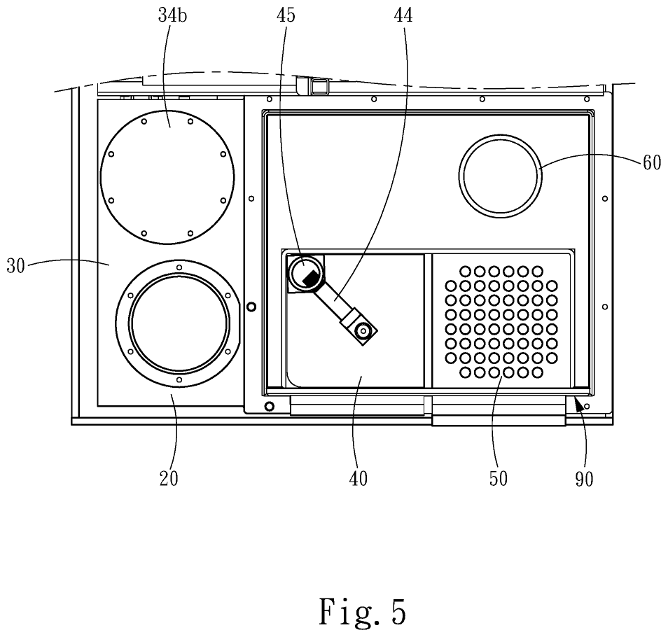

Referring to FIG. 3A, 3B, FIG. 4 and FIG. 5, an embodiment of the present invention. This embodiment is a water scrubbing type apparatus for treating gas pollutants, including a gas inlet part 10, a first scrubbing tower 20, a circulating water tank 30, a second scrubbing tower 40, a third scrubbing tower 50, a post-treatment tower 60, a pump pipe part 70 and a control part 80. In this embodiment, the second scrubbing tower 40, the third scrubbing tower 50 and the post-treatment tower 60 are integrated in a tank body 90. The gas inlet part 10 is disposed above the first scrubbing tower 20. The first scrubbing tower 20, the second scrubbing tower 40, the third scrubbing tower 50 and the post-treatment tower 60 are disposed adjacent to one another. Owing to the flow direction of gas in the apparatus of the present embodiment, a compact configuration is achieved.

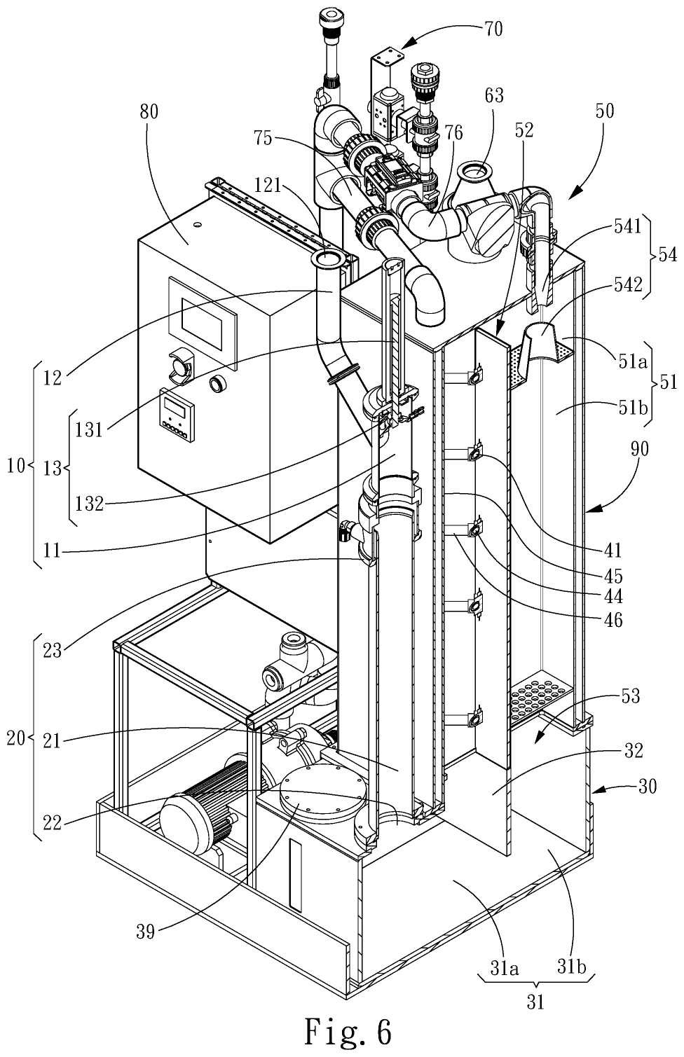

FIG. 6 is a schematic three-dimensional cross-sectional view taken along B-B of FIG. 4. Viewed from a direction D1, the gas inlet part 10 is installed at a top end, and the gas inlet part 10 includes a gas inlet chamber 11, at least one gas inlet tube 12 and a cleaning element 13, wherein the at least one gas inlet tube 12 is substantially obliquely installed in the gas inlet chamber 11 and communicates with the gas inlet chamber 11, the at least one gas inlet tube 12 is inclined with respect to a wall surface of the gas inlet chamber 11 at an angle, and the angle is less than 45°, preferably between 35° and 45°. During operation, a waste gas flowing out from the semiconductor process enters the gas inlet chamber 11 from the at least one gas inlet tube 12, and moves down from a bottom end of the gas inlet chamber 11 to leave. Since the at least one gas inlet tube 12 is disposed obliquely, the problem that the waste gas inlets too fast and may not be fully treated can be avoided. As shown in the figure, the gas inlet part 10 is installed vertically, and the waste gas moves down along the flow direction after leaving the bottom end of the gas inlet chamber 11. The cleaning element 13 includes a moving element 131 and a cleaning head 132, the cleaning head 132 is connected to one end of the moving element 131, and the cleaning head 132 is driven by the moving element 131 to move down, so as to clean dust, particles or dirt adhering to the gas inlet chamber 11.

The first scrubbing tower 20 is coupled to a bottom end of the gas inlet part 10 and communicates with the gas inlet part 10 to receive the waste gas. The first scrubbing tower 20 extends vertically and includes a first chamber 21, a first bottom opening 22 and a water storage tank 23. The water storage tank 23 is disposed on an outer side of the first chamber 21. The water storage tank 23 is connected to a water source through a liquid inlet 24, thereby supplying water to the water storage tank 23. The water in the water storage tank 23 will flow into the first chamber 21 from a liquid inlet 24 positioned in an upper portion and flow down along an inner wall 211 of the first chamber 21 to form a water curtain, so as to flush the waste gas entering the first chamber 21 and clean dust, particles or dirt adhering to the inner wall 211. The first chamber 21 communicates with the circulating water tank 30 via the first bottom opening 22.

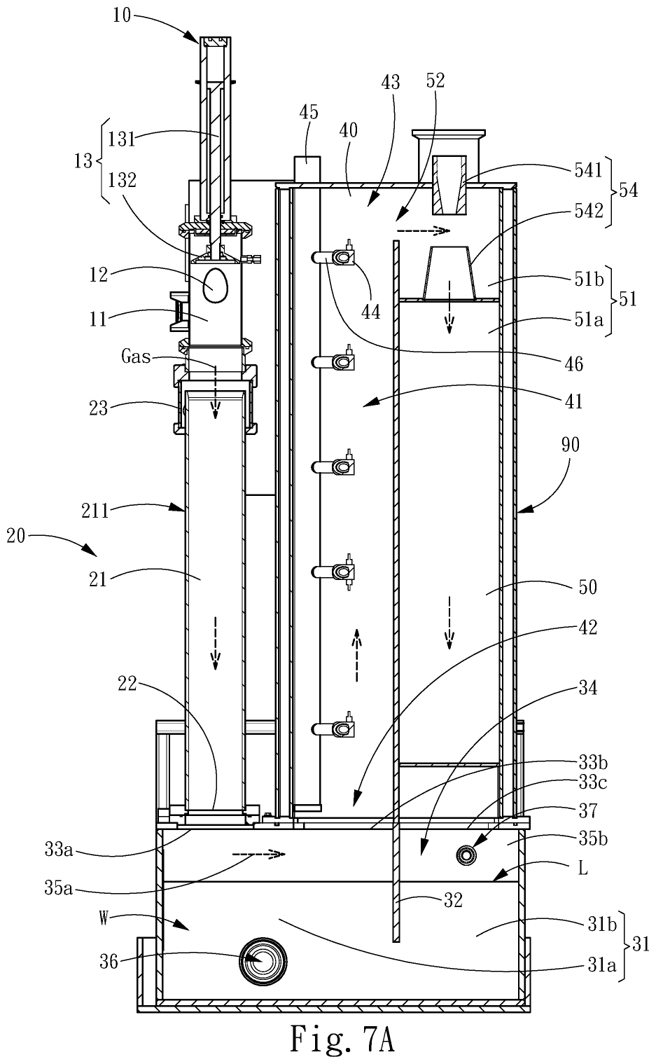

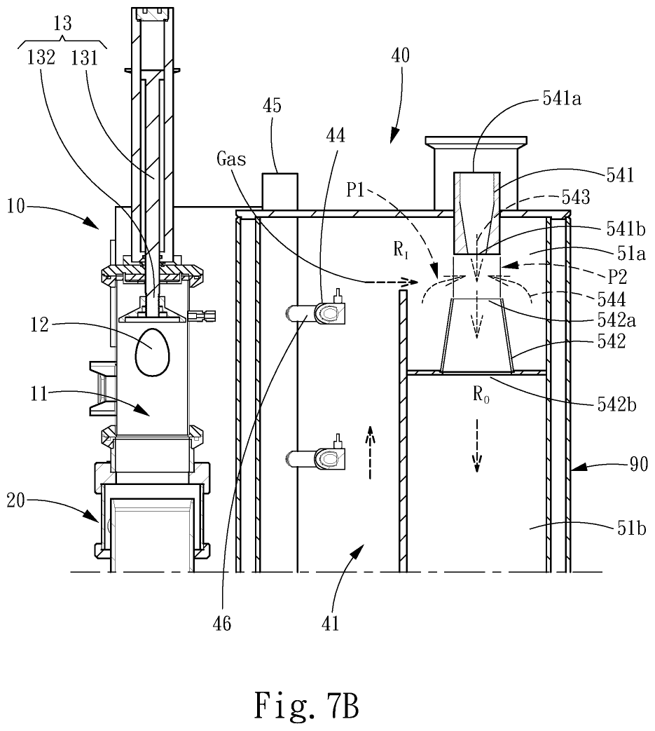

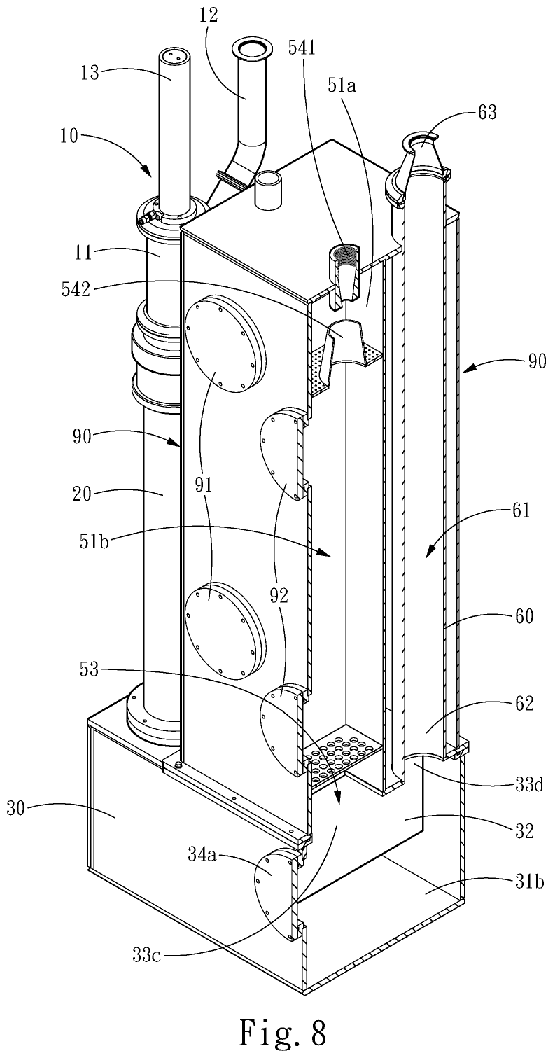

FIG. 7A to FIG. 7B are schematic cross-sectional views taken along B-B of FIG. 4. FIG. 8 is a schematic three-dimensional cross-sectional view taken along C-C of FIG. 4. Viewed from a direction D2, the circulating water tank 30 is disposed below the first scrubbing tower 20, and is coupled to bottom ends of the first scrubbing tower 20, the second scrubbing tower 40 and the third scrubbing tower 50. The circulating water tank 30 includes a water collection space 31, a barrier 32, a first upper opening 33a, a second upper opening 33b, a third upper opening 33c and a fourth upper opening 33d. The barrier 32 is disposed in the water collection space 31 and divides the water collection space 31 into a first region 31a and a second region 31b. The first region 31a and the second region 31b communicate with each other at a bottom. The water collection space 31 stores water W which flows cyclically. A surface level L of the water is lower than a top 34 of the circulating water tank 30 and higher than a bottom end of the barrier 32. Accordingly, channels 35a, 35b for lateral movement of the waste gas are respectively remained in the first region 31a and the second region 31b. The first upper opening 33a and the second upper opening 33b communicate with the first region 31a, the first upper opening 33a communicates with the first scrubbing tower 20, and the second upper opening 33b communicates with the second scrubbing tower 40. The third upper opening 33c and the fourth upper opening 33d communicate with the second region 31b, the third upper opening 33b communicates with the third scrubbing tower 50, and the fourth upper opening 33c communicates with the post-treatment tower 50. In addition, the circulating water tank 30 further includes an extraction hole 36, a water inlet 37, a side cover 38 (shown in FIG. 3A) and a top cover 39 (shown in FIG. 3A). The extraction hole 36 is coupled to the pump pipe part 70. The water inlet 37 is configured to supply fresh water. The side cover 38 and the top cover 39 may be opened or closed for an operator to perform operation such as cleaning, maintenance or repair.

The second scrubbing tower 40 is disposed adjacent to the first scrubbing tower 20, and is coupled to an upper portion of the circulating water tank 30, so as to receive the waste gas leaving from the circulating water tank 30. The second scrubbing tower 40 extends vertically and includes a second chamber 41, a second bottom opening 42, a second top opening 43, a plurality of eductors 44, a conveying tube 45 and a plurality of connecting tubes 46. The second bottom opening 42 of the second chamber 41 communicates with the second upper opening 34 of the circulating water tank 30. The conveying tube 45 is erectly disposed in the second chamber 41 and is connected to the plurality of eductors 44 via the plurality of connecting tubes 46 so as to supply a sprayed liquid to the plurality of eductors 44. In the present invention, a spray direction of the plurality of eductors 44 is set to be same as the flow direction of the waste gas in the second chamber 41, that is, the spray direction of the plurality of eductors 44 is parallel to the flow direction. In other embodiments, the spray direction of the plurality of eductors 44 may be set to be opposite against the flow direction.

The third scrubbing tower 50 is disposed adjacent to the second scrubbing tower 40. The third scrubbing tower 50 includes a third chamber 51, a third top opening 52, a third bottom opening 53, a flow-guiding device 54 and at least one packed bed. The third top opening 52 is laterally connected to the second top opening 43 so that the third chamber 51 communicates with the second chamber 41. The third chamber 51 includes an upper compartment 51a and a lower compartment 51b. The flow-guiding device 54 is disposed in the upper compartment 51a. The flow-guiding device 54 includes a fluid supply tube 541 and a flow-guiding tube 542.

The flow-guiding device 54 defines an input direction, an output direction and a driving direction. The input direction is not parallel to the output direction and the driving direction, and the output direction is the same as the driving direction. In this embodiment, the input direction (a horizontal direction) is substantially perpendicular to the output direction (a vertical direction). In an example, the flow-guiding device 54 guides a flow of the waste gas by using a passive suction force, and the passive suction force is not generated by an action of the mechanical structure. The second top opening 43 of the second scrubbing tower 40 is defined as an inflow region R₁, and the lower compartment 51b of the third scrubbing tower 50 is defined as an outflow region R_{O}. A first channel P1 is formed between the outflow region R_{O} and the inflow region R_{I}. The fluid supply tube 541 is disposed vertically and positioned above the flow-guiding tube 542. The fluid supply tube 541 and the flow-guiding tube 542 are aligned and spaced apart from each other. A second channel P2 is defined between the fluid supply tube 541 and the flow-guiding tube 542. The second channel P2 is positioned in the first channel P1. The fluid supply tube 541 includes a top opening 541a and a bottom opening 541b. The top opening 541a is connected to a liquid source, and the bottom opening 541b is a nozzle. The flow-guiding tube 542 includes a top opening 542a and a bottom opening 542b. The top opening 542a is positioned in the upper compartment 51a, and the bottom opening 542b is positioned in the lower compartment 51b. The fluid supply tube 541 supplies an injection fluid 543 to the flow-guiding tube 542, whereby a pressure difference is generated between the first channel P1 and the second channel P2, so that a suction force 544 is generated. The suction force 544 defines a lateral gas inlet region between the fluid supply tube 541 and the flow-guiding tube 542. The suction force 544 drives the waste gas from the inflow region R₁ into the outflow region R_{O}. In other words, the injection fluid 543 induces a driving force for guiding a gas flow to flow toward and out of the bottom opening 542b of the flow-guiding tube 542 to be generated between the fluid supply tube 541 and the flow-guiding tube 542. In addition, in this embodiment, the fluid supply tube 541 is in the shape of a cone with a narrow top and a wide bottom. The lower compartment 51b is a packed bed chamber. A plurality of packings are stacked to form the packed bed. The packings are made from, for example, polyvinyl chloride (PVC).

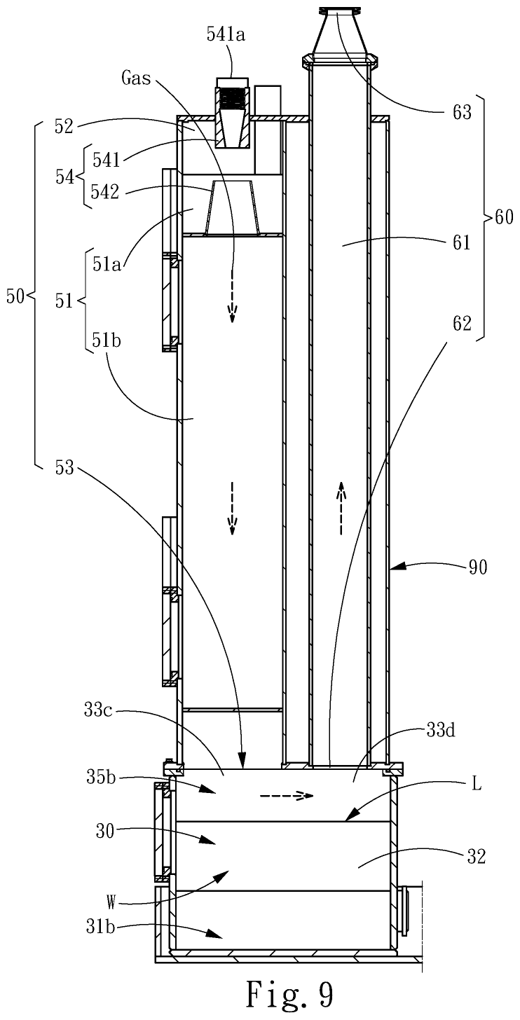

Referring to FIG. 3A, FIG. 8 and FIG. 9, the post-treatment tower 60 is disposed above the circulating water tank 30 and adjacent to the second scrubbing tower 40. The post-treatment tower 60 includes a fourth chamber 61, a fourth bottom opening 62 and a fourth top opening 63. The fourth chamber 61 communicates with the circulating water tank 30 through the fourth bottom opening 62. In this embodiment, the post-treatment tower 60 provides the functions of drying, dehydration and/or nitride removal. For example, the post-treatment tower 60 may include an electro-catalytic converter, such as an electro-catalytic honeycomb component or an electro-catalytic double-cell plate component.

In this embodiment, the apparatus further includes a pump pipe part 70 (the pump pipe part 70 is not configured to extract the waste gas). The pump pipe part 70 includes a first pump component 71, a second pump component 72, a first pipe 73, a second pipe 74, a third pipe 75, a fourth pipe 76, a fifth pipe 77 and a water inlet pipe 78. The first pipe 73 is respectively connected to the first pump component 71 and the extraction hole 36 of the circulating water tank 30, the second pipe 74 is respectively connected to the second pump component 72, the third pipe 75 and the fourth pipe 76, the third pipe 75 is connected to the conveying tube 45 of the second scrubbing tower 40, the fourth pipe 76 is connected to the fluid supply tube 541 of the flow-guiding device 54 of the third scrubbing tower 50, and the fifth pipe 77 is connected between the first pump component 71 and the second pump component 72. The pump pipe part 70. In the other aspect, according to other embodiments of the present invention, the fourth top opening 63 of the post-treatment tower 60 may also be selectively connected to a gas extraction apparatus, thereby increasing the extraction efficiency of the waste gas. In this example, the tank body 90 is divided into a plurality of chambers to serve as the second scrubbing tower 40, the third scrubbing tower 50 and the post-treatment tower 60. The tank body 90 further includes a plurality of first front cover plate 91 and a plurality of second front cover plates 92. The plurality of first front cover plates 91 are disposed corresponding to the second scrubbing tower 40, and the second front cover plates 92 are disposed corresponding to the third scrubbing tower 50. The plurality of first front cover plates 91 and the second front cover plates 92 may be opened or closed for the operator to perform operation such as cleaning, maintenance or repair. In other embodiments, the second scrubbing tower 40, the third scrubbing tower 50 and the post-treatment tower 60 may also adopt other structural configurations.

Operationally, in the first scrubbing tower 20, the water in the water storage tank 23 will flow into the first chamber 21 and form the water curtain. In the second scrubbing tower 40, the second pump component 72 pumps the water to the conveying tube 45 of the second scrubbing tower 40 via the second pipe 74 and the third pipe 75, so as to generate a plurality of sprays in the second scrubbing tower 40 via the plurality of eductors 44. In the third scrubbing tower 50, the second pump component 72 pumps the water to the fluid supply tube 541 of the flow-guiding device 54 of the third scrubbing tower 50 via the second pipe 74 and the fourth pipe 76, so as to make the waste gas to be sucked into the third scrubbing tower 50 as the liquid source. The first pump component 71 is configured to pump out the water in the circulating water tank 30. The first pump component 71 and the second pump component 72 are further connected to each other by the fifth pipe 77. In this way, through proper filtration, the water in the circulating water tank 30 may be pumped out to serve as the water source of the second scrubbing tower 40 and the third scrubbing tower 50, so as to optimize the water consumption. The control part 80 is configured to control an action of a valve on each pipe, which is a technology well known to those skilled in the art, and will not be described again here.

According to an aspect of the present invention, an apparatus for treating gaseous pollutants is provided, which includes a first space, a second space and a flow-guiding device 54. For example, the first space is an internal space of the second scrubbing tower 40, and the second space is an internal space of the third scrubbing tower 50. The first space may be directly or indirectly coupled to a gas source and receive a gas pollutant from the gas source, and the second space is fluidly connected to the first space. The flow-guiding device 54 is installed in a first channel P1 between an outflow region R_{O} of the second space and an inflow region R_{I} of the first space. The first channel P1 extends in a direction. The flow-guiding device 54 includes a fluid supply tube 541 disposed close to the inflow region R_{I} and a flow-guiding tube 542 disposed close to the outflow region R_{O}. The fluid supply tube 541 and the flow-guiding tube 542 are spaced apart from each other along the direction, and a second channel P2 positioned in the first channel P1 is formed between the fluid supply tube 541 and the flow-guiding tube 542, wherein the fluid supply tube 541 supplies an injection fluid to the flow-guiding tube 542, whereby a pressure difference is generated between the first channel P1 and the second channel P2, and the pressure difference drives the gaseous pollutant to enter the outflow region R_{O} from the inflow region R_{I}.

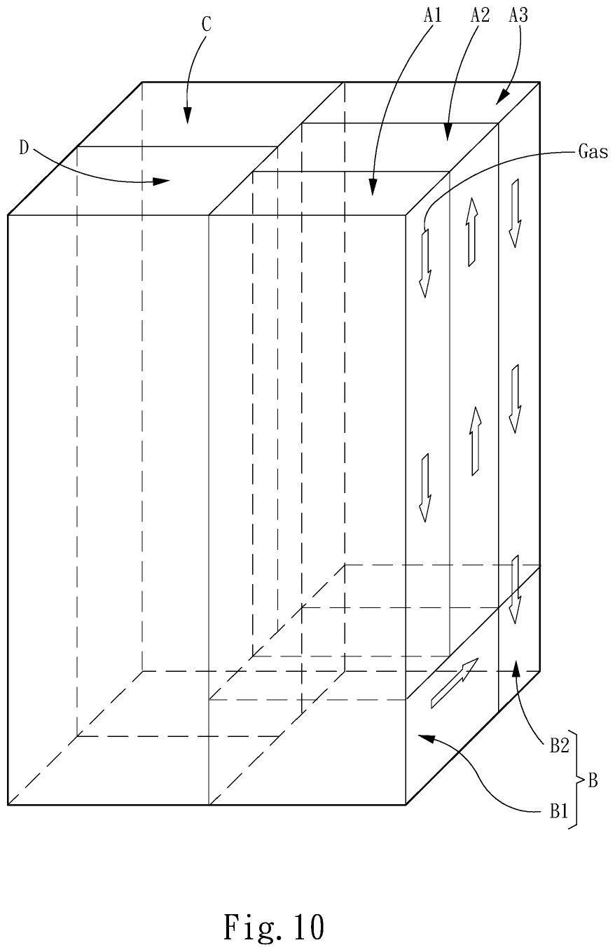

In summary, in an embodiment, an apparatus for treating gas pollutants disclosed by the present invention takes into account the flow direction of the waste gas, the configuration of each scrubber/component and the treatment mode of the waste gas, and under the simplified spatial arrangement, the maximum treatment efficiency is achieved. Continuing to refer to FIG. 10, FIG. 10 is a schematic diagram according to an embodiment of the present invention. The apparatus includes a first region A1, a second region A2, a third region A3, a fourth region B, a fifth region C and a sixth region D. The first region A1, the second region A2, the third region A3, the fifth region C and the sixth region D extend vertically, and the fourth region B extends transversely. The first region A1, the second region A2 and the third region A3 accommodate scrubbers with different functions respectively, the fourth region B is a water tank, the fifth region C accommodates components such as pump pipes, conveying pipes or valves, and the sixth region D accommodates electronic devices or operation panels for control (the fifth region C and the sixth region D may also be exchanged).

The first region A1, the second region A2 and the third region A3 are arranged side by side in a manner of being adjacent to one another on a same side, and are jointly connected to the fourth region B downwards. The fourth region B includes a first part B1 and a second part B2. The first region A1 and the second region A2 are connected to each other via the first part B1, the second region A2 is connected to the third region A3, and the third region A3 is further connected to other components through the second part B2. The fifth region C and the sixth region D are arranged side by side in a manner of being adjacent to each other on a same side, and are appropriately connected to hardware in the first region A1, the second region A2, the third region A3 and the fourth region B.

1. An apparatus for treating gaseous pollutants, comprising:
a gas inlet part, comprising a gas inlet chamber and at least one guide pipe, the at least one guide pipe communicating with the gas inlet chamber and guiding an effluent stream from a semiconductor process to the gas inlet chamber;
a first scrubbing tower, coupled to a bottom end of the gas inlet part, extending vertically and comprising a first top opening communicating with the gas inlet chamber, a first chamber communicating with the first top opening, an inner wall in the first chamber, a liquid inlet laterally communicating with the first chamber, and a first bottom opening communicating with the first chamber, the liquid inlet being configured to allow a water flow entering the first chamber so as to form a water curtain along the inner wall;
a second scrubbing tower, disposed adjacent to the first scrubbing tower, extending vertically and comprising a second bottom opening communicating with the first chamber, a second chamber communicating with the second bottom opening, a second top opening communicating with the second chamber, and a plurality of eductors disposed in the second chamber;
a third scrubbing tower, disposed adjacent to the second scrubbing tower, extending vertically and comprising a third top opening communicating with the second chamber, a third chamber communicating with the third top opening, a third bottom opening communicating with the third chamber, a flow-guiding device disposed adjacent to the third top opening, and at least one packed bed positioned below the flow-guiding device to receive a gas flow from the flow-guiding device; and
a circulating water tank, coupled to bottom ends of the first scrubbing tower, the second scrubbing tower and the third scrubbing tower, and comprising a water collection space for storing a liquid, a first upper opening, a second upper opening and a third upper opening, the first upper opening, the second upper opening and the third upper opening respectively communicating with the first chamber, the second chamber and the third chamber, and the water collection space comprising a first region, a second region and a barrier disposed between the first region and the second region;
wherein the first region forms, between the first bottom opening of the first scrubbing tower and the second bottom opening of the second scrubbing tower, a first flow channel exposed to the liquid and configured to allow the effluent stream flowing from the first scrubbing tower to the third scrubbing tower through the second scrubbing tower, and the second region receives the effluent stream driven by the flow-guiding device of the third scrubbing tower.

2. The apparatus for treating gaseous pollutants according to claim 1, wherein the flow-guiding device is disposed in an upper compartment of the third chamber, and the upper compartment laterally communicates with the third top opening and downwardly communicates with the at least one packed bed.

3. The apparatus for treating gaseous pollutants according to claim 2, wherein the flow-guiding device comprises a fluid supply tube disposed vertically, a flow-guiding tube positioned below the fluid supply tube, and a lateral gas inlet region positioned between the fluid supply tube and the flow-guiding tube, the flow-guiding tube is aligned with the fluid supply tube to receive an injection fluid from the fluid supply tube, and the injection fluid generates a driving force in the lateral gas inlet region for guiding the gas flow to flow toward and out of an opening of the flow-guiding tube.

4. The apparatus for treating gaseous pollutants according to claim 3, wherein the flow-guiding tube is in the shape of a cone with a narrow top and a wide bottom.

5. The apparatus for treating gaseous pollutants according to claim 1, wherein the flow-guiding device is a non-mechanical flow-guiding device.

6-10. (canceled)
